(19) United States
(12) Patent Application Publication
(10) Pub. No.: US 2024/0135190 A1
(43) Pub. Date: Apr. 25, 2024

(54) LEVERAGING OFFLINE TRAINING DATA AND AGENT COMPETENCY MEASURES TO IMPROVE ONLINE LEARNING

(71) Applicant: DeepMind Technologies Limited, London (GB)

(72) Inventors: Zheng Wen, Fremont, CA (US); Benjamin Van Roy, Stanford, CA (US); Rahul Anant Jain, Malibu, CA (US); Botao Hao, Redwood City, CA (US)

(21) Appl. No.: 18/492,415

(22) Filed: Oct. 22, 2023

Related U.S. Application Data
(60) Provisional application No. 63/418,267, filed on Oct. 21, 2022.
(60) Provisional application No. 63/490,377, filed on Mar. 15, 2023.

(51) Int. Cl. G06N 3/092

(52) U.S. Cl. CPC G06N 3/092

(57) ABSTRACT

Methods, systems, and apparatus, including computer programs encoded on a computer storage medium, for training a target action selection policy to control a target agent interacting with an environment. In one aspect, a method comprises: obtaining a set of offline training data, wherein the offline training data characterizes interaction of a baseline agent with an environment as the baseline agent performs actions selected in accordance with a baseline action selection policy; generating a set of online training data that characterizes interaction of the target agent with the environment as the target agent performs actions selected in accordance with the target action selection policy; and training the target action selection policy on both: (i) the offline training data, and (ii) the online training data, wherein the training of the target action selection policy on the offline training data is conditioned on a measure of competency of the baseline agent.

### CROSS-REFERENCE TO RELATED APPLICATION

This application claims priority under 35 U.S.C. 119 to Provisional Application No. 63/418,267, filed October 21, 2022, and Provisional Application No. 63/490,377, filed March 15, 2023, both which are incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non- linear transformation to a received input to generate an output.

### SUMMARY

This specification generally describes a system implemented as computer programs on one or more computers in one or more locations for training a target action selection policy to control a target agent interacting with an environment, e.g., to perform one or more tasks in the environment.

Throughout this specification, an “observation” can refer to any appropriate data characterizing the state of an environment, e.g., data that is captured by a sensor of an agent interacting with the environment.

According to a first aspect, there is provided a method performed by one or more computers, the method comprising: obtaining a set of offline training data, wherein the offline training data characterizes interaction of a baseline agent with an environment as the baseline agent performs actions selected in accordance with a baseline action selection policy; training a target action selection policy to control a target agent interacting with the environment, comprising: generating a set of online training data that characterizes interaction of the target agent with the environment as the target agent performs actions selected in accordance with the target action selection policy; and training the target action selection policy on both: (i) the offline training data, and (ii) the online training data, wherein the training of the target action selection policy on the offline training data is conditioned on a measure of competency of the baseline agent.

In some implementations, the baseline action selection policy is different than the target action selection policy.

In some implementations, generating the set of online training data comprises, for each time step in a sequence of time steps: selecting an action to be performed by the target agent at the time step using the target action selection policy; receiving a reward based on the action performed by the target agent at the time step; and adding an online experience tuple for the time step to the set of online training data, wherein the online experience tuple defines: (i) the action performed by the target agent at the time step, and (ii) the reward received based on the action performed by the target agent at the time step.

In some implementations, the offline training data comprises a plurality of offline experience tuples, wherein each offline experience tuple corresponds to a respective time step and defines: (i) an action performed by the baseline agent at the time step, and (ii) a reward received at the time step based on the action performed by the baseline agent at the time step.

In some implementations, the target action selection policy is parameterized by a set of target action selection policy parameters, and wherein training the target action selection policy comprises, at each of one or more time steps in the sequence of time steps: determining updated values of the set of target action selection policy parameters based on an objective function that depends on: (i) the target action selection policy parameters, (ii) the measure of competency of the baseline agent, (iii) the offline training data, and (iv) the online training data; and setting current values of the set of target action selection policy parameters equal to the updated values of the set of target action selection policy parameters.

In some implementations, the objective function comprises a reinforcement learning loss.

In some implementations, the reinforcement learning loss is evaluated over at least a portion of the online training data.

In some implementations, the reinforcement learning loss is evaluated over the offline training data and the online training data.

In some implementations, the objective function comprises an imitation learning loss that characterizes a similarity between: (i) the target action selection policy, and (ii) the baseline action selection policy.

In some implementations, the imitation learning loss depends on the measure of competency of the baseline agent.

In some implementations, the method further comprises, at each of one or more time steps in the sequence of time steps: determining an updated value of the competency measure of the baseline agent based on the objective function; and setting a current value of the competency measure of the baseline agent equal to the updated value of the competency measure of the baseline agent.

In some implementations, determining the updated value of the competency measure of the baseline agent based on the objective function comprises: determining a gradient of the objective function with respect to the competency measure of the baseline agent; and determining the updated value of the competency measure of the baseline agent using the gradient of the objective function with respect to the competency measure of the baseline agent.

In some implementations, determining updated values of the set of target action selection policy parameters based on the objective function comprises: determining a gradient of the objective function with respect to the set of target action selection policy parameters; and determining the updated values of the set of target action selection policy parameters using the gradient of the objective function with respect to the set of target action selection policy parameters.

In some implementations, the target action selection policy is implemented as a neural network.

In some implementations, the measure of competency of the baseline agent is based at least in part on an amount of exploration performed by the baseline agent in the environment.

In some implementations, the measure of competency of the baseline agent is based at least in part on how quickly the baseline agent can perform tasks in the environment.

In some implementations, the measure of competency of the baseline agent is based at least in part on a number of tasks that the baseline agent can perform in the environment.

In some implementations, determining the measure of competency of the baseline agent comprises: determining the measure of competency of the baseline agent based on the offline training data characterizing the interaction of the baseline agent with the environment.

According to another aspect, there is provided a system comprising: one or more computers; and one or more storage devices communicatively coupled to the one or more computers, wherein the one or more storage devices store instructions that, when executed by the one or more computers, cause the one or more computers to perform operations of the methods described herein.

According to another aspect, there are provided one or more non-transitory computer storage media storing instructions that when executed by one or more computers cause the one or more computers to perform operations of the methods described herein.

Particular embodiments of the subject matter described in this specification can be implemented so as to realize one or more of the following advantages.

This specification describes a system for training a “target” action selection policy to control a “target” agent interacting with an environment, e.g., to perform a task in the environment. The system can train the target action selection policy using both: (i) online training data, e.g., that is generated in accordance with the target action selection policy, and (ii) offline training data, e.g., that is generated in accordance with a different, “baseline” action selection policy. The system can adapt the training of the target action selection policy on the offline training data to account for the quality of the offline training data, in particular, to account for a level of “competence” of the baseline agent that generated by the offline training data. By training the target action selection policy on offline training data, the system can enable the target action selection policy to achieve an acceptable performance (e.g., on one or more tasks) using less online training data than would otherwise be required. Moreover, training the target action selection policy in a manner that accounts for the competency of the baseline agent that generated by offline training data can increase the robustness and generalizability of the target action selection policy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for training an action selection neural network on a set of online training data and a set of offline training data.

FIG. 3 is a flow diagram of an example process for updating the current values of the set of action selection neural network parameters based on online training data, offline training data, and a competency measure of the baseline agent that generated by the offline training data.

FIG. 4 shows experimental results that compare: (i) iRLSVI (training the target action selection policy using offline data and a competency measure); (ii) piRLSVI (training the target action selection policy using offline data but without the competency measure); and (iii) uRLSVI (training the target action selection policy without the offline data).

Like reference numbers and designations in the various drawings indicate like elements.

### DETAILED DESCRIPTION

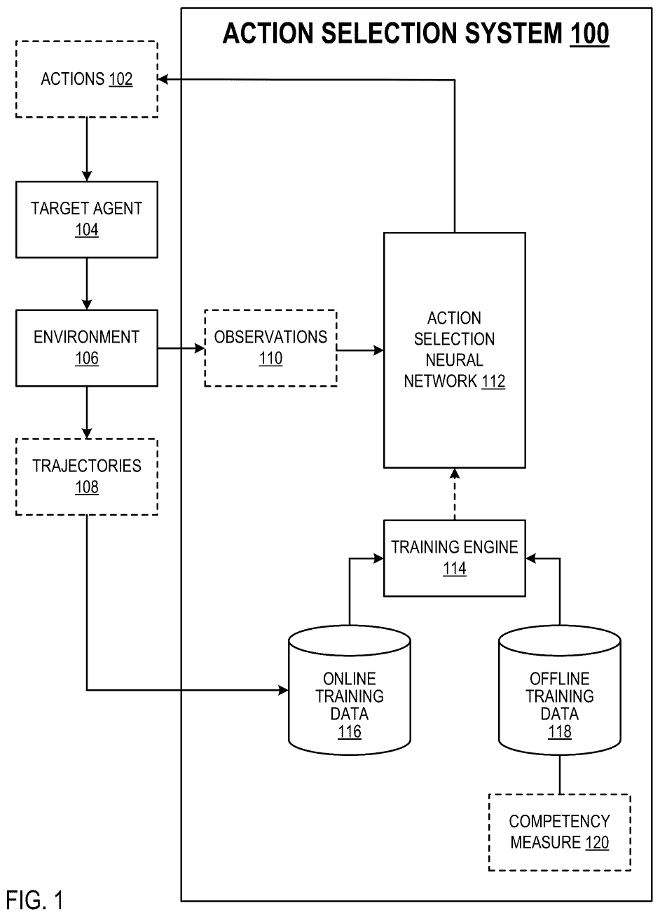

FIG. 1 shows an example action selection system 100. The action selection system 100 is an example of a system implemented as computer programs on one or more computers in one or more locations in which the systems, components, and techniques described below are implemented.

The system 100 is configured to control an agent 104, referred to for convenience as a “target” agent, that interacts with an environment 106 over a sequence of time steps, e.g., to perform one or more tasks in the environment 106. In particular, at each time step, the system 100 can process an observation 110 characterizing a current state of the environment 106 to select an action 102 to be performed by the target agent 104 at the time step.

The system 100 can receive a receive a reward at one or more time steps, e.g., based at least in part on the action 102 performed by the target agent 104 at the time step, the observation 110 characterizing the current state of the environment 106 at the time step, or both. The reward can be represented as a numerical value and can characterize a progress of the target agent 104 in accomplishing one or more tasks in the environment.

A few examples of agents, environments, tasks, and rewards, are described next for illustrative purposes.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform a task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/ intermediates/ precursors and/or may be derived from simulation.

In a similar way the environment may be a drug design environment such that each state is a respective state of a potential pharmaceutical drug and the agent is a computer system for determining elements of the pharmaceutical drug and/or a synthetic pathway for the pharmaceutical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to recreate in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

In some implementations, the environment is a (real or simulated) medical environment that includes a population of subjects. A “subject” can be, e.g., a cell, a collection of cells, an animal (e.g., a mouse, a rat, a cat, a dog, etc.), or a person. The agent can perform actions from a set of actions that include one or more medical treatment actions. Each medical treatment action can correspond to causing a respective medical treatment (e.g., a particular level of a drug, or a particular therapy) to be applied (e.g., administered) to a subject.

The agent can receive a reward as a result of selecting a medical treatment action, e.g., based on a result of applying the corresponding medical treatment to a subject, e.g., based on a change in one or more physiological parameters of the subject (e.g., gene expression levels, cholesterol levels, blood sugar levels, etc.), based on a level of side effects experienced by the subject from the medical treatment, or based on any other appropriate aspect of the response of the subject to receiving the medical treatment.

The system 100 includes an action selection neural network 112, a training engine 114, a set of online training data 116, and a set of offline training data 118, which are each described in more detail next (and throughout this specification).

The action selection neural network 112 implements an action selection policy (referred to for convenience as a “target” action selection policy) for selecting actions 102 to be performed by the target agent 104 over a sequence of time steps. In particular, at each time step, the action selection neural network 112 processes a network input that includes an observation characterizing the state of the environment at the time step to generate an action selection output. The system 100 can then select the action 102 to be performed by the target agent 104 at the time step using the action selection output. A few examples of action selection outputs are described next.

In some implementations, the action selection neural network 112 generates an action selection output that directly specifies an action to be performed by the target agent, e.g., by defining torques to be applied to one or more joints of the target agent. In these implementations, the system 100 can select the action specified in the action selection output as the action to be performed by the target agent.

In some implementations, the action selection neural network 112 generates a distribution over a set of possible actions, where the distribution assigns a respective score to each action in the set of possible actions. The system 100 can select the action to be performed by the target agent based on the distribution in a variety of possible ways. For instance, the system 100 can select the action associated with the highest score under the distribution as the action to be performed by the target agent. As another example, the system 100 generate a probability distribution over the set of possible actions, e.g., by processing the distribution over the set of possible action using a soft-max function, and then sample the action to be performed by the target agent in accordance with the probability distribution.

Optionally, the system can select the actions to be performed by the agent based at least in part on an exploration policy, e.g., that encourages the selection of actions that cause the agent to explore the environment. For instance, the exploration policy can be an E-greedy exploration policy, e.g., where the system 100 causes the agent to perform an action that is selected randomly (i.e., rather than an action selected using the action selection neural network) with some predefined probability at each time step. As another example, the action selection output of the action selection neural network can define a distribution over the set of possible actions, and implementing the exploration policy can involve processing the distribution using a soft-max function associated with a temperature parameter having a value that is selected to increase the dispersion of the resulting probability distribution over the set of possible actions.

The action selection neural network 112 can have any appropriate neural network architecture that enables the action selection neural network 112 to perform its described functions. In particular, the action selection neural network 112 can include any appropriate types of neural network layers (e.g., self-attention layers, fully connected layers, convolutional layer, and so forth) in any appropriate numbers (e.g., 5 layers, 10 layers, or 50 layers) and connected in any appropriate configuration (e.g., as a directed graph of layers).

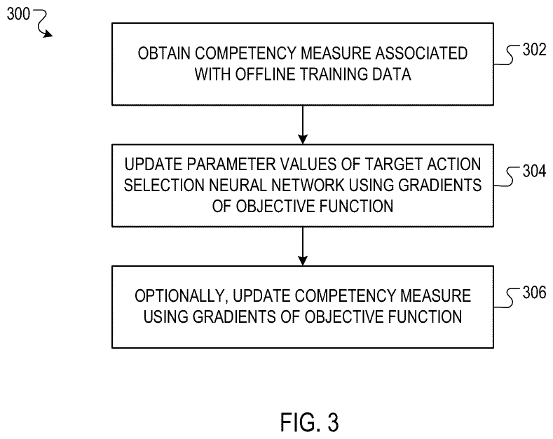

The training engine 114 is configured to train the action selection neural network 112, e.g., by iteratively adjusting the values of a set of action selection neural network parameters to optimize an objective function. The objective function can include, e.g., a reinforcement learning loss, or an imitation learning loss, or both. Examples of objective functions are described in more detail below with reference to FIG. 3.

The training engine 114 can train the action selection neural network using both: (i) the set of online training data 116, and (ii) the set of offline training data 118.

The online training data 116 characterizes interaction of the agent 104 with the environment 106 as the agent performs actions selected in accordance with the target action selection policy implemented by the action selection neural network 112, e.g., the action selection policy defined by the current values of the set of action selection neural network parameters. The system 100 can populate the set of online training data 116 with trajectories 108 representing interactions of the target agent with the environment 106 as the target agent 104 is controlled using the target action selection policy. (A “trajectory” can refer to data that defines, for each time step in a sequence of time steps, an observation characterizing the state of the environment at the time step, an action performed by the agent at the time step, and optionally, a reward received by the agent at the time step).

The set of offline training data 118 characterizes interaction of an agent (referred to for convenience as a “baseline” agent) with the environment as the baseline agent performs actions selected in accordance with a “baseline” action selection policy to accomplish one or more tasks. The baseline action selection policy used to generate the offline training data 118 is in general different than the target action selection policy used to generate the online training data 116. A few examples of possible baseline action selection policies are described next.

In some implementations, the baseline action selection policy can be specified by a person, e.g., as the person manually controls the baseline agent by selecting actions to be performed by the baseline agent by way of an appropriate interface, e.g., a joystick, mouse, or touchscreen.

In some implementations, the baseline action selection policy can be implemented by a controller such as a proportional-integral-derivative (PID) controller, or a model predictive controller (MPC), or a sliding mode controller, and so forth.

In some implementations, the baseline action selection policy is implemented by a baseline action selection neural network that has, e.g., a different architecture, different parameter values, or both, than the action selection neural network 112 that implements the target action selection policy.

The baseline agent, i.e., that interacted with the environment to generate the offline training data, can be the same agent as the target agent, or can be a different instance of the target agent, or more generally can be any agent that can perform some or all of the actions in the set of actions available to the target agent. For instance, if the baseline and target agents are mechanical agents, then the baseline agent and the target agent can be the same agent; or the baseline agent can be a separate instantiation of a mechanical agent having the same or similar structure (e.g., mechanical configuration) as the target agent; or the baseline agent can be a mechanical agent having a different structure (e.g., mechanical configuration) than the target agent but that can perform some or all of the same actions as the target agent (e.g., actions to control a robotic actuator, or to navigate through an environment, and so forth).

Training the action selection neural network 112 on the offline training data 118 in addition to the online training data 116 can improve the performance of the action selection neural network 112. For instance, the offline training data 118 can encode information about the environment and about various strategies for solving tasks in the environment, and training the action selection neural network 112 on the offline training data 118 can enable the action selection neural network to leverage this information to more effectively control the target agent.

A baseline action selection policy used to generate the offline training data 118 can be “competent” to varying degrees. For instance, the baseline action selection policy can be an expert action selection policy, e.g., that selects near-optimal actions for effectively perform tasks. As another example, the baseline action selection policy can be a random action selection policy, e.g., that selects actions randomly. More generally, a baseline action selection policy can be associated with a competency measure 120 that characterizes how effectively an agent that performs actions selected in accordance with the baseline action selection policy accomplishes one or more tasks in the environment. The competency measure 120 can be expressed, e.g., as a numerical value, and example processes for determining the competency measure 120 are described in more detail below with reference to FIG. 3.

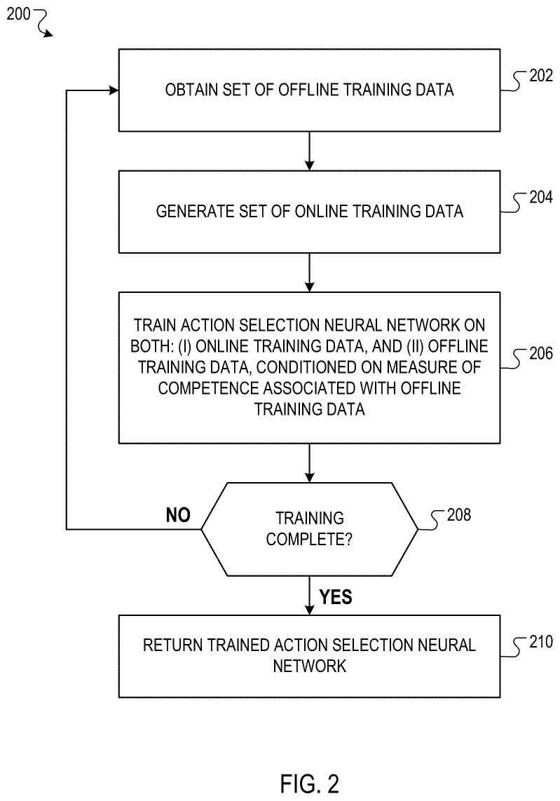

The training engine 114 can condition the training of the action selection neural network 112 on the offline training data 118 on the competency measure 120. That is, the training engine 114 can take the competency measure 120 into account during the training of the action selection neural network 112 on the offline training data 118, and in doing so, can improve the performance of the action selection neural network 112. The system 100 can determine the competency measure 120 even when the particular task being performed by the baseline agent that generated the offline training data 118 is unknown, or when rewards are not associated with the trajectories included in the offline training data 118. Example processes for conditioning the training of the action selection neural network 112 on the competency measure 120 are described in more detail next with reference to FIG. 2 and FIG. 3.

Over the course of training, the training engine 114 iteratively updates the values of the set of action selection neural network parameters. Each time the training engine 114 updates the set of action selection neural network parameters, the target action selection policy changes and previously generated trajectories may no longer qualify as “online” trajectories. The training engine 114 can address this issue, e.g., by clearing the set of online training data at each parameter update of the action selection neural network, or by training the action selection neural network using an off-policy training procedure that incorporates correction factors (e.g., Retrace or V-trace correction factors) to account for the off-policy discrepancy, or in any other appropriate way.

FIG. 2 is a flow diagram of an example process 200 for training an action selection neural network on a set of online training data and a set of offline training data. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system obtains a set of offline training data (202). The offline training data characterizes interactions of a baseline agent with the environment as the baseline agent performs actions selected in accordance with a baseline action selection policy. The baseline action selection policy can be implemented by a person, or by a control system (e.g., a PID controller or an MPC controller), or by a baseline action selection neural network, or in any other appropriate way, as described above with reference to FIG. 1.

The offline training data can include a set of offline experience tuples that each correspond to a respective time step and define: (i) an action performed by the baseline agent at the time step, and (ii) an observation characterizing the state of the environment at the time step. Optionally, one or more of the offline experience tuples can further include data defining a reward received by the baseline agent at the corresponding time step. The offline training data can include any appropriate number of offline experience tuples, e.g., 1000 offline experience tuples, or 100,000 offline experience tuples, or 1,000,000 offline experience tuples.

The system can obtain the offline training data in any of a variety of possible ways. For instance, the system can access offline training data that is stored in one or more local or remote data storage devices. As another example, the system can receive the offline training data, e.g., from a user by way of an application programming interface (API) made available by the system.

The system generates a set of online training data (204). The online training data characterizes interactions of the target agent with the environment as the target agent performs actions selected in accordance with the target action selection policy implemented by the action selection neural network.

The online training data can include a set of online experience tuples that each correspond to a respective time step and define: (i) an action performed by the target agent at the time step, (ii) an observation characterizing the state of the environment at the time step, and (iii) a reward received by the target agent at the time step. The online training data can include any appropriate number of online experience tuples, e.g., 1000 online experience tuples, or 100,000 online experience tuples, or 1,000,000 online experience tuples.

To generate the set of online training data, the system can control the target agent using the action selection neural network over a sequence of time steps. More specifically, at each time step, the system can process an observation characterizing the state of the environment at the time step using the action selection neural network and in accordance with the current values of the set of action selection neural network parameters to select the action to be performed by the agent. The system can also receive a reward at the time step, e.g., based at least in part on the state of the environment at the time step and/or the action performed by the target agent at the time step. The system can generate a respective online experience tuple for each time step that defines the observation, action, and reward for the time step.

The system trains the action selection neural network on the online training data and the offline training data (206). The system conditions the training of the action selection neural network on the offline training data on a competency measure of the baseline agent that generated the offline training data. An example process for updating the current values of the set of action selection neural network parameters based on online training data, offline training data, and a competency measure of the baseline agent that generated by the offline training data is described with reference to FIG. 3.

The system determines whether a termination criterion for the training has been satisfied (208). For instance, the system can determine that a termination criterion has been satisfied if the system has performed at least a predefined number of iterations of the steps 202 — 206. As another example, the system can determine that a termination criterion has been satisfied if the performance of the target agent, e.g., as evaluated through a cumulative measure of rewards received by the target agent, satisfies a threshold.

In response to determining that the termination criteria for the training have not been satisfied, the system returns to step 202.

In response to determining that one or more termination criteria for the training have been satisfied, the system returns the trained action selection neural network (210). For instance, the system can provide the trained action selection neural network for use in controlling the agent.

FIG. 3 is a flow diagram of an example process 300 for updating the current values of the set of action selection neural network parameters based on online training data, offline training data, and a competency measure of the baseline agent that generated by the offline training data. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system obtains a competency measure characterizing a competence of the baseline action selection policy of the baseline agent that generated the offline training data (302). A few example techniques for obtaining the competency measure of the baseline action selection policy are described next.

In some implementations, to generate the competency measure for the baseline action selection policy, the system processes the offline training data to determine a distribution over the set of possible actions that can be performed by the baseline agent. The distribution can assign a respective score to each action based on how frequently that action was performed by the baseline agent among the offline experience tuples included in the offline training data. The system can then determine the competency measure for the baseline action selection policy based on a measure of dispersion (e.g., a measure of entropy or a variance) of the distribution over actions in the offline training data. For instance, the system can determine the competency measure as an inverse of the measure of dispersion of the distribution over actions in the offline training data. Intuitively, a higher dispersion among the actions performed in the offline training data can indicate that the baseline action selection policy selects actions more randomly and thus less competently.

In some implementations, the system generates the competency measure based at least in part on a rate of environment exploration performed by the baseline action selection policy. For instance, to generate the competency measure, the system can cluster the observations included in the offline experience tuples by a clustering process that adaptively determines the number of clusters to be generated during the clustering. In this example, the system can determine the competency measure based on a number of clusters generated during the clustering. Intuitively, a higher number of observation clusters can be indicative of greater exploration of the environment by the baseline agent. The system can generate the competency measure, e.g., as a ratio of: (i) a numerator equal to (or based on) the number of clusters generated during the clustering, and (ii) a denominator equal to (or based on) the number of offline experience tuples in the set of offline experience tuples. Normalizing the competency measure based on the number of offline experience tuples can cause the competency measure to capture the rate (rather than just the amount) of exploration.

In some implementations, the system generates the competency measure based at least in part on how quickly the baseline agent performed tasks when controlled by the baseline action selection policy. For instance, the system can generate the competency measure based on a number of experience tuples in the offline training data where the observation in the experience tuple indicates that the environment is in a “goal” state indicating completion of a task. For instance, for a mechanical agent performing a task of assembling components on an automated assembly line, the environment can be in a goal state if the components being assembled by the mechanical agent are in a desired configuration. The system can generate the competency measure, e.g., as a ratio of: (i) a numerator equal to (or based on) the number of offline experience tuples with an observation characterizing a goal state, and (ii) a denominator equal to (or based on) the number of offline experience tuples in the set of offline experience tuples.

In some implementations, the system generates the competency measure based at least in part on a number of distinct tasks that the baseline agent can perform in the environment when controlled using the baseline action selection policy. For instance, given a set of tasks, the system can generate the competency measure based on a number of tasks for which the offline training data includes at least a threshold proportion of experience tuples where the observation in the experience tuple indicates that the environment is in a goal state indicating completion of the task. The threshold proportion can be, e.g., 0.1%, 1%, 10%, or any other appropriate proportion. For instance, for a mechanical agent performing tasks of assembling components on an automated assembly line, each task can correspond to a respective desired configuration of the components.

In some implementations, the system can generate the competency measure as a linear combination of one or more of: (i) a measure of dispersion (e.g., a measure of entropy or a variance) of the distribution over actions in the offline training data, (ii) the rate of environment exploration performed by the baseline action selection policy, (iii) the rate at which the baseline agent performs tasks when controlled using the baseline action selection policy, or (iv) the number of distinct tasks that the baseline agent can perform when controlled by the baseline action selection policy.

In some implementations, the system initializes the competency measure at the first training iteration (e.g., the first iteration of steps 202-206 in FIG. 2), e.g., randomly or using one or more the techniques described above, and then iteratively adjusts the competency measure over the course of training. An example technique for adjusting the competency measure at a training iteration is described below (with reference to step 306).

The system updates the current values of the set of action selection neural network parameters using gradients of an objective function evaluated on the online training data and the offline training data (304).

The objective function can include: (i) a reinforcement learning loss, and (ii) an imitation learning loss.

The reinforcement learning loss can be, e.g., a policy gradient loss, or a Q learning loss, or an actor critic loss, and so forth. In some implementations, the reinforcement learning loss corresponds to an online reinforcement learning technique, and the system evaluates the reinforcement learning loss over only the online training data. In some implementations, the reinforcement learning loss corresponds to an offline reinforcement learning technique, and the system evaluates the reinforcement learning loss over both the online training data and the offline training data. Generally, the reinforcement learning loss encourages the action selection neural network to select actions that increase a cumulative measure of rewards received by the target agent as a result of interacting with the environment by performing actions selected using the action selection neural network.

The imitation learning loss can measure a similarity between: (i) the target action selection policy implemented by the action selection neural network, and (ii) the baseline action selection policy that generated the offline training data. In particular, the imitation learning loss can encourage an increase in similarity between the target action selection policy and the baseline action selection policy.

The imitation learning loss can be implemented so as to depend on the competency measure of the baseline agent. Intuitively, the degree to which the target action selection policy should be adapted through training to become more similar to the baseline action selection policy may depend on the competency measure of the baseline action selection policy. For instance, adapting the target action selection policy to become more similar to a baseline action selection policy with a high competency measure may improve the performance of the target action selection policy. However, adapting the target action selection policy to become more similar to a baseline action selection policy with a low competency measure may diminish the performance of the target action selection policy.

In a particular example, the imitation learning loss may be given by:

$${ℒ}_{IL} = - {\sum }_{l = 1}^{L} {\sum }_{h = 0}^{H - 1} ( β {Q}_{h}^{θ} ( {s}_{h}^{{l}_{1}} , {a}_{h}^{l} ) - log {\sum }_{b} exp ( β {Q}_{h}^{θ} ( {s}_{h}^{l} , b ) ) ) \qquad ( 1 )$$

where l indexes episodes, h indexes time steps, β indexes actions, denotes the competency measure, and Qₕ^{θ}(s, a) denotes the state — action value generated by the action selection neural network for state s and action a.

The objective function can be given by a combination of the reinforcement learning loss and the imitation learning loss, e.g., the objective function L may given by:

L=αL_{RL}(θ)+(1−α)L_{IL}(β, θ)+λβ (2)

where α is a constant value that controls the relative strength of the reinforcement learning loss and the imitation learning loss in the objective function, λ is a constant, L_{RL}(θ) is the reinforcement learning loss, L_{IL}(β, θ) is the imitation learning loss, and β is the competency measure of the baseline action selection policy.

Optionally, the system can update the competency measure associated with the offline training data (306). For instance, the system can determine a gradient of the objective function with respect to the competency measure (e.g., denoted β in equations (1)-(2)) and then update the value of the competency measure using the gradient. The system can thus iteratively learn an appropriate value for the competency measure over the course of training.

In steps 304-306, the system can determine the gradients of the objective function using backpropagation, and can update the values of the action selection neural network parameters and the competency measure using the update rule of any appropriate gradient descent optimization technique, e.g., RMSprop or Adam.

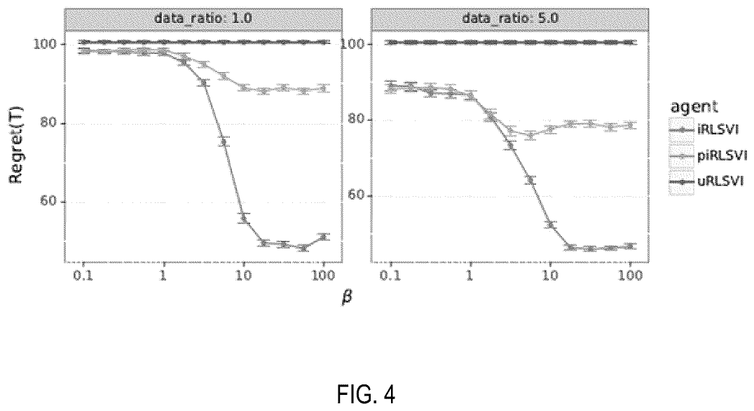

FIG. 4 shows experimental results that compare: (i) iRLSVI (training the target action selection policy using offline data and a competency measure); (ii) piRLSVI (training the target action selection policy using offline data but without the competency measure); and (iii) uRLSVI (training the target action selection policy without the offline data). The horizontal axis defines the competency measure, and the vertical axis defines the performance of the target action selection policy (where lower is better). The plot on the left corresponds to an experiment with a smaller set of offline training data (“data_ratio=1.0”) and the plot on the right corresponds to an experiment with a large set of offline training data (“data_ratio=5.0”).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a set of offline training data, wherein the offline training data characterizes interaction of a baseline agent with an environment as the baseline agent performs actions selected in accordance with a baseline action selection policy;
training a target action selection policy to control a target agent interacting with the environment, comprising:
generating a set of online training data that characterizes interaction of the target agent with the environment as the target agent performs actions selected in accordance with the target action selection policy; and
training the target action selection policy on both: (i) the offline training data, and (ii) the online training data, wherein the training of the target action selection policy on the offline training data is conditioned on a measure of competency of the baseline agent.

2. The method of claim 1, wherein the baseline action selection policy is different than the target action selection policy.

3. The method of claim 1, wherein generating the set of online training data comprises, for each time step in a sequence of time steps:
selecting an action to be performed by the target agent at the time step using the target action selection policy;
receiving a reward based on the action performed by the target agent at the time step; and
adding an online experience tuple for the time step to the set of online training data, wherein the online experience tuple defines: (i) the action performed by the target agent at the time step, and (ii) the reward received based on the action performed by the target agent at the time step.

4. The method of claim 3, wherein the offline training data comprises a plurality of offline experience tuples, wherein each offline experience tuple corresponds to a respective time step and defines: (i) an action performed by the baseline agent at the time step, and (ii) a reward received at the time step based on the action performed by the baseline agent at the time step.

5. The method of claim 3, wherein the target action selection policy is parameterized by a set of target action selection policy parameters, and wherein training the target action selection policy comprises, at each of one or more time steps in the sequence of time steps:
determining updated values of the set of target action selection policy parameters based on an objective function that depends on: (i) the target action selection policy parameters, (ii) the measure of competency of the baseline agent, (iii) the offline training data, and (iv) the online training data; and
setting current values of the set of target action selection policy parameters equal to the updated values of the set of target action selection policy parameters.

6. The method of claim 5, wherein the objective function comprises a reinforcement learning loss.

7. The method of claim 6, wherein the reinforcement learning loss is evaluated over at least a portion of the online training data.

8. The method of claim 7, wherein the reinforcement learning loss is evaluated over the offline training data and the online training data.

9. The method of claim 5, wherein the objective function comprises an imitation learning loss that characterizes a similarity between: (i) the target action selection policy, and (ii) the baseline action selection policy.

10. The method of claim 9, wherein the imitation learning loss depends on the measure of competency of the baseline agent.

11. The method of claim 10, further comprising, at each of one or more time steps in the sequence of time steps:
determining an updated value of the competency measure of the baseline agent based on the objective function; and
setting a current value of the competency measure of the baseline agent equal to the updated value of the competency measure of the baseline agent.

12. The method of claim 11, wherein determining the updated value of the competency measure of the baseline agent based on the objective function comprises:
determining a gradient of the objective function with respect to the competency measure of the baseline agent; and
determining the updated value of the competency measure of the baseline agent using the gradient of the objective function with respect to the competency measure of the baseline agent.

13. The method of claim 5, wherein determining updated values of the set of target action selection policy parameters based on the objective function comprises:
determining a gradient of the objective function with respect to the set of target action selection policy parameters; and
determining the updated values of the set of target action selection policy parameters using the gradient of the objective function with respect to the set of target action selection policy parameters.

14. The method of claim 1, wherein the target action selection policy is implemented as a neural network.

15. The method of claim 1, wherein the measure of competency of the baseline agent is based at least in part on an amount of exploration performed by the baseline agent in the environment.

16. The method of claim 1, wherein the measure of competency of the baseline agent is based at least in part on how quickly the baseline agent can perform tasks in the environment.

17. The method of claim 1, wherein the measure of competency of the baseline agent is based at least in part on a number of tasks that the baseline agent can perform in the environment.

18. The method of claim 1, wherein determining the measure of competency of the baseline agent comprises:
determining the measure of competency of the baseline agent based on the offline training data characterizing the interaction of the baseline agent with the environment.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a set of offline training data, wherein the offline training data characterizes interaction of a baseline agent with an environment as the baseline agent performs actions selected in accordance with a baseline action selection policy;
training a target action selection policy to control a target agent interacting with the environment, comprising:
generating a set of online training data that characterizes interaction of the target agent with the environment as the target agent performs actions selected in accordance with the target action selection policy; and
training the target action selection policy on both: (i) the offline training data, and (ii) the online training data, wherein the training of the target action selection policy on the offline training data is conditioned on a measure of competency of the baseline agent.

20. One or more non-transitory computer storage media storing instructions that when executed by one or more computers cause the one or more computers to perform operations comprising:
obtaining a set of offline training data, wherein the offline training data characterizes interaction of a baseline agent with an environment as the baseline agent performs actions selected in accordance with a baseline action selection policy;
training a target action selection policy to control a target agent interacting with the environment, comprising:
generating a set of online training data that characterizes interaction of the target agent with the environment as the target agent performs actions selected in accordance with the target action selection policy; and
training the target action selection policy on both: (i) the offline training data, and (ii) the online training data, wherein the training of the target action selection policy on the offline training data is conditioned on a measure of competency of the baseline agent.
